(19) United States
(12) Patent Application Publication
(10) Pub. No.: US 2012/0150546 A1
(43) Pub. Date: Jun. 14, 2012

(54) APPLICATION STARTING SYSTEM AND METHOD

(75) Inventors: CHENG-CHUNG CHENG, Tu-Cheng (TW); YONG LI, Shenzhen City (CN); JUN-WEI TAO, Shenzhen City (CN); XING-ZHEN WANG, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 13/217,245

(22) Filed: Aug. 25, 2011

(30) Foreign Application Priority Data
Dec. 13, 2010 (CN) 201010584979.3

(51) Int. Cl. G10L 21/00

(52) U.S. Cl. 704/275; 704/E11.001

(57) ABSTRACT

A computing device and method starts applications via voice commands. The computing device records a sound input by a microphone of the computing device and sends the recorded sound input to a sound sensor of the computing device. Furthermore, the computing device reads a voice command by an embedded controller of the computing device from the sound sensor, in response to a determination that the recorded sound input matches a predetermined verbal statement of the voice command. The computing device notifies an operating system of the computing device to start the application corresponding to the voice command.

### BACKGROUND

1. Technical Field

The embodiments of the present disclosure relate to file processing technology, and particularly to an application starting system and method.

2. Description of Related Art

Application software is software designed to perform a singular or multiple related specific tasks. For example, a user may use a web browser (e.g., INTERNET EXPLORER) to retrieve, present, and traverse information resources on the Internet. In order to start a web browser, the user needs to double-click on a shortcut icon of the web browser. More useful and convenient methods to start the application are desired by users.

### BRIEF DESCRIPTION OF THE DRAWINGS

FIG. 1 is a system view of one embodiment of a computing device.

FIG. 2 is a block diagram of one embodiment of the computing device of FIG. 1.

FIG. 3 is a flowchart of one embodiment of an application start method.

### DETAILED DESCRIPTION

The disclosure is illustrated by way of examples and not by way of limitation in the figures of the accompanying drawings in which like references indicate similar elements. It should be noted that references to “an” or “one” embodiment in this disclosure are not necessarily to the same embodiment, and such references mean at least one.

In general, the word “module”, as used herein, refers to logic embodied in hardware or firmware, or to a collection of software instructions, written in a programming language, such as, Java, C, or assembly. One or more software instructions in the modules may be embedded in firmware, such as in an EPROM. The modules described herein may be implemented as either software and/or hardware modules and may be stored in any type of non-transitory computer-readable medium or other storage device. Some non-limiting examples of non-transitory computing device-readable media include CDs, DVDs, BLU-RAY, flash memory, and hard disk drives.

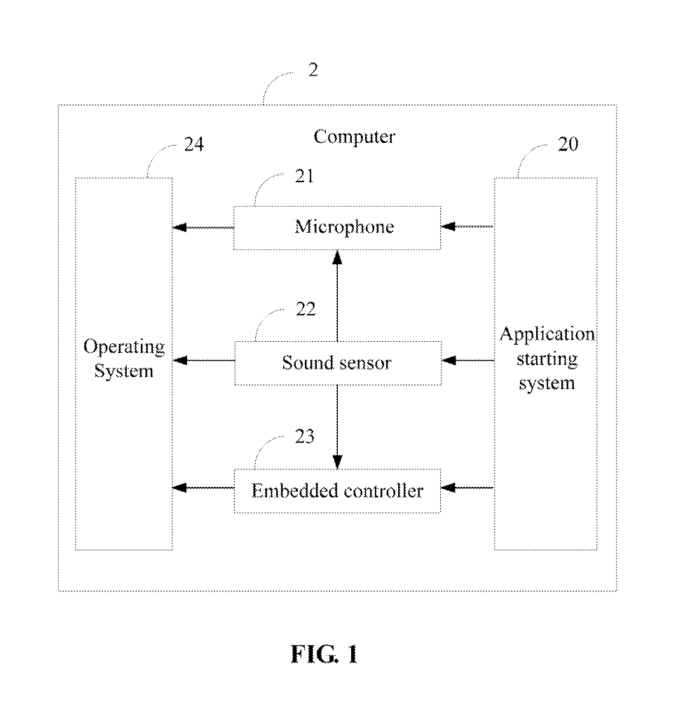

FIG. 1 is a system view of one embodiment of a computing device 2. In one embodiment, the computing device 2 may include an application starting system 20, a microphone 21, a sound sensor 22, an embedded controller 23, and an operating system 24. The application starting system 20 may be used to start applications via voice commands. Further details of the application starting system 20 will be described below.

The microphone 21 is electronically connected to the sound sensor 22. The microphone 21 records sound input from a user and sends the sound input to the sound sensor 22. In one embodiment, the microphone 21 may be, but is not limited to, a condenser microphone, a dynamic microphone, a ribbon microphone, or a carbon microphone. For example, if a user makes a particular verbal statement (e.g., “open IE”) to the microphone 21, the microphone 21 records the sound input and sends the recorded sound input to the sound sensor 22 for analysis.

The sound sensor 22 is electronically connected to the microphone 21 and the embedded controller 23. The sound sensor 22 stores one or more voice commands. It is understood that the voice command is defined as a command including a predetermined verbal statement to start an application. For example, assuming that the voice command may be used to start a web browser (e.g., INTERNET EXPLORER), and the voice command includes a predetermined verbal statement “open IE”, when the user speaks a sound to the microphone 21, the sounder sensor 22 determines if the sound input from the microphone 21 matches the predetermined verbal statement. The embedded controller 23 reads the voice command from the sound sensor 22 if the sound input from the microphone 21 matches the predetermined verbal statement and notifies the operating system 24 to start the application. For example, the embedded controller 23 reads the voice command from the sound sensor 22 if the sound input from the microphone 21 is “open IE”, then notifies the operating system to start the INTERNET EXPLORER. Additionally, the operating system 24 may be, but is not limited to, a MICROSOFT WINDOWS operating system or a LINUX operating system.

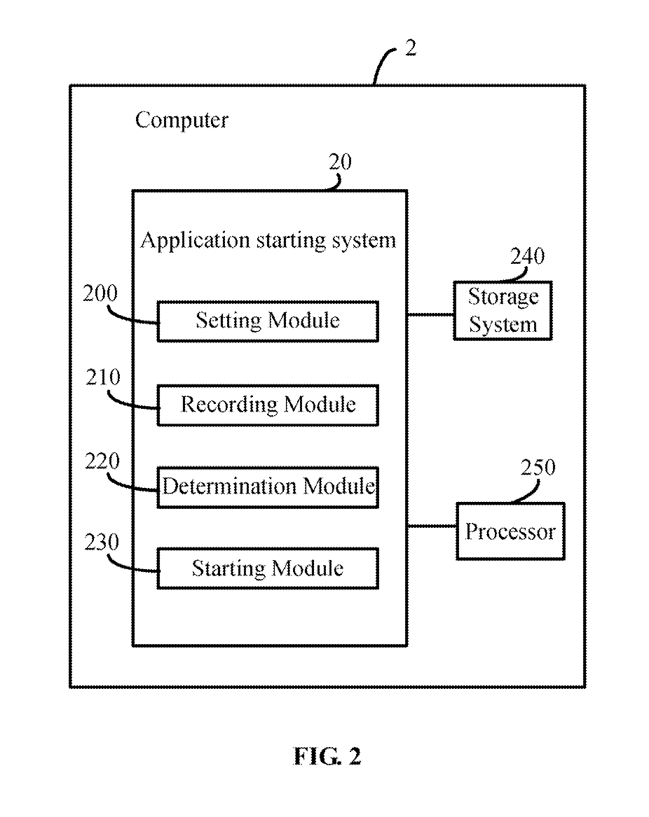

FIG. 2 is a block diagram of one embodiment of the computing device 2 including an application starting system 20. The application starting system 20 may be used to start applications via a voice command. In one embodiment, the computing device 2 includes a storage system 240, and at least one processor 250. In one embodiment, the application starting system 20 includes a setting module 200, a recording module 210, a determination module 220, and a starting module 230. The modules 200-230 may include computerized code in the form of one or more programs that are stored in a storage system 240. The computerized code includes instructions that are executed by the at least one processor 250 to provide functions for the modules 200-230. The storage system 240 may be a cache or a memory, such as an EPROM or a flash.

The setting module 200 sets a voice command for starting the application for the sound sensor 22. In one embodiment, the setting module 200 generates the voice command when the user speaks the predetermined verbal statement (e.g., “open IE”) to the microphone 21. The voice command may be subject to a person ID recognition (PID) mode or to a speaker independent recognition (SIR) mode. The user can choose the PID mode or the SIR mode in setting a voice command. The PID mode can recognize a sound input being targeted at a particular speaker. The SIR mode is a broader solution which can recognize a sound input without being targeted at the particular speaker.

The recording module 210 records a sound input by the microphone 21 and sends the recorded sound input to the sound sensor 22.

The determination module 220 uses the sound sensor 22 to determine if the recorded sound input matches the predetermined verbal statement of the voice command. In one embodiment, if the voice command is subject to the PID mode, the determination module 220 determines if the recorded sound input is “open IE” and if the recorded sound input is spoken by the particular user. If the voice command is the SIR mode, the determination module 220 determines if the recorded sound input is “open IE”.

The reading module 230 reads the voice command by the embedded controller 23 from the sound sensor 22 in response to a determination that the recorded sound input matches the predetermined verbal statement of the voice command.

The starting module 240 notifies the operating system 24 to start the application corresponding to the voice command In one embodiment, the starting module 240 notifies the operating system 24 using an advanced configuration and power management interface (ACPI). For example, if the recorded sound input and the predetermined verbal statement are the same, the starting module 230 uses the ACPI to notify the operating system to start the INTERNET EXPLORER.

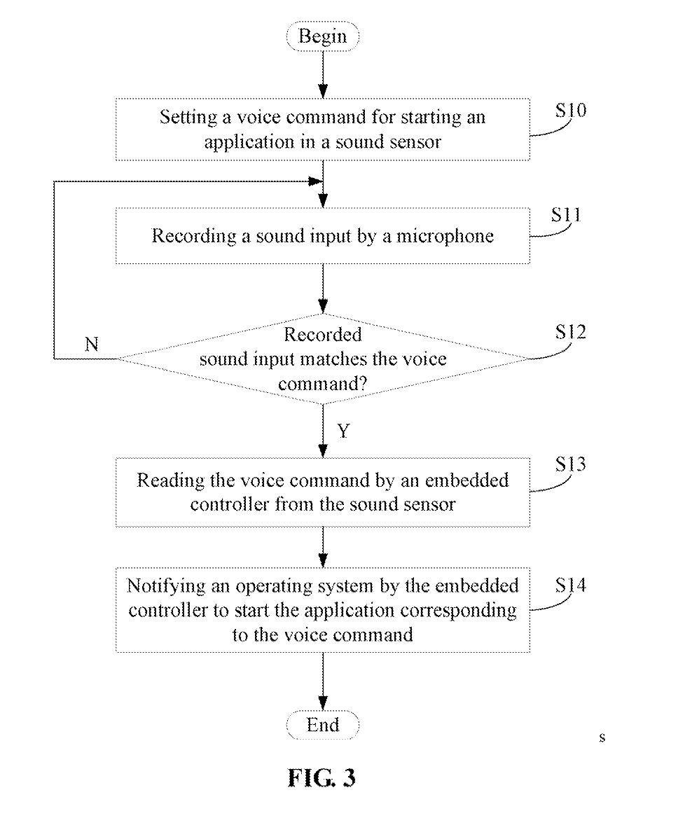

FIG. 3 is a flowchart of one embodiment of an application start method. Depending on the embodiment, additional blocks may be added, others deleted, and the ordering of the blocks may be changed.

In block S10, the setting module 200 sets a voice command for starting the application for the sound sensor 22. In one embodiment, the setting module 200 generates the voice command when the user speaks the predetermined verbal statement (e.g., “open IE”) to the microphone 21. As mentioned above, the voice command may be subject to a person ID recognition (PID) mode and a speaker independent recognition (SIR) mode.

In block S11, the recording module 210 records a sound input by the microphone 21 and sends the recorded sound input to the sound sensor 22.

In block S12, the determination module 220 uses the sound sensor 22 to determine if the recorded sound input matches the predetermined verbal statement of the voice command. In one embodiment, assuming that the voice command is subject to the PID mode and the predetermined verbal statement is spoken by the particular speaker whose name is “Amity”, if the recorded sound input is “open IE” and if the recorded sound input is spoken by “Amity”, the procedure goes to S13. Otherwise, if the recorded sound input is not “open IE” or if the recorded sound input is not spoken by “Amity”, the procedure returns to the block S11. In one embodiment, assuming that the voice command is subject to the SIR mode, if the recorded sound input is “open IE”, the procedure goes to S13. Otherwise, if the recorded sound input is not “open IE”, the procedure returns to S11.

In block S13, the reading module 230 reads the voice command by the embedded controller 23 from the sound sensor 22.

In block S14, the starting module 240 notifies the operating system 24 to start the application corresponding to the voice command. For example, if the recorded sound input and the predetermined verbal statement are the same, the starting module 230 uses the ACPI to notify the operating system to start the INTERNET EXPLORER.

Although certain inventive embodiments of the present disclosure have been specifically described, the present disclosure is not to be construed as being limited thereto. Various changes or modifications may be made to the present disclosure without departing from the scope and spirit of the present disclosure.

What is claimed is:

1. A computing device, comprising:
a microphone;
a sound sensor;
an embedded controller;
a storage system;
at least one processor; and
one or more programs stored in the storage system and being executable by the at least one processor, the one or more programs comprising:
a setting module operable to set a voice command for the sound sensor, wherein the voice command is operable to start an application of the computing device;
a recording module operable to record a sound input by the microphone and send the recorded sound input to the sound sensor;
a determination module operable to use the sound sensor to determine if the recorded sound input matches a predetermined verbal statement of the voice command;
a reading module operable to use the embedded controller to read the voice command from the sound sensor in response to a determination that the recorded sound input matches the predetermined verbal statement of the voice command; and
a starting module operable to notify an operating system of the computing device to start the application corresponding to the voice command.

2. The computing device of claim 1, wherein the microphone is selected from the group consisting of a condenser microphone, a dynamic microphone, a ribbon microphone, and a carbon microphone.

3. The computing device of claim 1, wherein voice command is a person ID recognition (PID) mode or a speaker independent recognition (SIR) mode.

4. The computing device of claim 1, wherein the starting module notifies the operating system using an advanced configuration and power management interface (ACPI) to start the application corresponding to the voice command.

5. A method implemented by a computing device, the computing device comprising a sound sensor, a microphone, an embedded controller, the method comprising:
setting a voice command for the sound sensor, wherein the voice command is operable to start an application of the computing device;
recording a sound input by a microphone of the computing device and sending the recorded sound input to a sound sensor of the computing device;
using the sound sensor to determine if the recorded sound input matches a predetermined verbal statement of the voice command;
using an embedded controller of the computing device to read the voice command from the sound sensor in response to a determination that the recorded sound input matches the predetermined verbal statement of the voice command; and
notifying an operating system of the computing device to start the application corresponding to the voice command.

6. The method of claim 5, wherein the microphone is selected from the group consisting of a condenser microphone, a dynamic microphone, a ribbon microphone, and a carbon microphone.

7. The method of claim 5, wherein voice command is a person ID recognition (PID) mode or a speaker independent recognition (SIR) mode.

8. The method of claim 5, wherein the application corresponding to the voice command is started by notifying the operating system using an advanced configuration and power management interface (ACPI).

9. A non-transitory computing device-readable medium having stored thereon instructions that, when executed by a computing device, the computing device comprising a sound sensor, a microphone, an embedded controller, causing the computing device to perform an application start method, the method comprising:
setting a voice command for the sound sensor, wherein the voice command is operable to start an application of the computing device;
recording a sound input by a microphone of the computing device and sending the recorded sound input to a sound sensor of the computing device;
using the sound sensor to determine if the recorded sound input matches a predetermined verbal statement of the voice command;
using an embedded controller of the computing device to read the voice command from the sound sensor in response to a determination that the recorded sound input matches the predetermined verbal statement of the voice command; and
notifying an operating system of the computing device to start the application corresponding to the voice command.

10. The medium of claim 9, wherein the microphone is selected from the group consisting of a condenser microphone, a dynamic microphone, a ribbon microphone, and a carbon microphone.

11. The medium of claim 9, wherein voice command is a person ID recognition (PID) mode or a speaker independent recognition (SIR) mode.

12. The medium of claim 9, wherein the application corresponding to the voice command is started by notifying the operating system using an advanced configuration and power management interface (ACPI).
